(19) United States
(12) Patent Application Publication
(10) Pub. No.: US 2005/0197060 A1
(43) Pub. Date: Sep. 8, 2005

(54) Scalable multi-satellite spot beam architecture

(76) Inventors: Robert A. Hedinger, Red Bank, NJ (US); James W. Carlin, Holmdel, NJ (US); Peter E. Goettle, Hamilton, NJ (US)

Correspondence Address: KARAMBELAS & ASSOCIATES, 655 DEEP VALLEY DRIVE, SUITE 303, ROLLING HILLS ESTATES, CA, 90274, US

(21) Appl. No.: 10/793,021

(22) Filed: Mar. 4, 2004

(51) Int. Cl. H04B 7/15; H04B 7/185

(52) U.S. Cl. 455/12.1; 455/11.1

(57) ABSTRACT

A scalable multi-satellite spot-beam network architecture that employs a plurality (N) of relatively small (low power) active spot beam satellites and a number (R) of spare satellites, all of which are substantially similar in design, has been described. The plurality of satellites is substantially collocated at a given orbital location to provide coverage of a desired geographic area. Each active satellite has 1/N of the total capacity of a slot, and there is significant amount of interchangeability among the active and spare satellites, enabling the spare and active satellites to provide protection against partial or full failures of any satellite or even a few (up to R) satellites. The system is scalable since a fraction of the N active satellites is required to provide capacity to the full geographic area, and additional satellites can be launched and additional gateways can be deployed to augment the network capacity. Communication devices (users) located in any of the spot beams communicate with each other and the worldwide telecommunications network via satellites and gateways of the scalable system architecture.

### BACKGROUND

The present invention relates to the implementation of the space segment portion of communications networks, that employ geostationary spot-beam satellites for 1- or 2-way communications with user terminals 13. The invention calls for multiple collocated satellites, in which individual satellites or groups of satellites possess a high degree of interchangeability, and the space segment capacity over a fixed geographic region can be expanded with the deployment of additional (collocated) satellites.

Current approaches for spot-beam satellite architectures that provide service to large geographic areas, such as the continental US (CONUS) or Europe, use a very large, high-power, satellite, one that would consume about 15 kW of prime power to provide a large number of contiguous user spot beams—on the order of 100 with diameters as small as a few hundred miles—and a substantial quantity of frequency re-use—on the order of 10 to 20 times. The systems may use satellites having complex on-board switching/processing to directly connect terminals 13 in different user spot beams which may be referred to as “connectivity” satellites, or the systems may have satellites connecting users in a given set of beams to a gateway and then to other users through the worldwide ground network which are referred to as “access” satellites.

A distinction is made between “user spot beams” or “user beams” and “gateway spot beams” or “gateway beams.” The satellite user beams are designed to provide generally contiguous coverage of the service area where the users' communication devices or terminals 13, which generally contain small antennas, are ubiquitously deployed, whereas the satellite gateway beams are designed to provide uplink and downlink coverage of the few gateways within the service area, which serve as access points to the worldwide terrestrial network for the users, who could be consumers, small enterprises, medium-sized businesses, or large corporations. The gateways generally contain large antennas. The number of gateway beams is generally less than the number of user beams, and the frequencies used by the uplink and downlink gateway beams will be different from those of the uplink and downlink user beams. Though unnecessary, the beam size and locations of the gateway beams may be the same as some of the user beams—convenience of the satellite design would determine this.

Typical large spot-beam access or connectivity satellites provide total throughput capability on the order of 10 Gbps and may support approximately 2,000,000 broadband users, in contrast to an equal power (15 kW) area-coverage satellite having about 1 Gbps capability that supports about 150,000 users for equivalent QOS (quality of service). The spot-beam satellite likely costs 50% to 100% more than the area-coverage satellite (not including launch), and it would likely take several years after launch of the spot-beam satellite until the full capacity is used. The connectivity satellite in general will be higher cost, power, and weight than an access satellite for a given capacity, because of the on board switching/processing. Although there is a very significant reduction in unit bandwidth cost for a large single spot-beam satellite compared to an area-beam satellite (perhaps by a factor of 5 or 10), the large initial capital investment and the uncertainty surrounding the take-up rate introduce substantial, and perhaps unacceptable, financial risk to these types of systems.

Further, with the large number of user antennas and the unique satellite design associated with a direct-to-user satellite service, the satellite is an especially vital component in the network. In the event of a total satellite failure, it is very unlikely that there would be a similar spot-beam satellite at another orbital location to which the user antennas could be re-pointed for service restoration, and the prospect of re-pointing 1 or 2 million user antennas to this backup satellite would be unacceptably time-consuming and expensive. Therefore, it is necessary to provide on-orbit backup capacity at the same orbital location to protect against a partial or full satellite failure. The approach for implementation of the spare capacity would most likely have a significant impact on the financial attractiveness of the project.

The generation of spot beams usually calls for satellites operating in the Ku 14/12 GHz or Ka 30/20 GHz commercial frequency bands, but the concepts discussed herein are applicable to other frequency bands, as well. The Ku- and Ka-band frequency bands may have transmission losses of 10 dB or more in heavy rain storms and may require the use of earth station diversity and/or high link margins e.g., >10 dB to provide a high availability e.g., >99.7% service at the gateways.

Thus, key objectives of the present invention are to provide for a cost-effective, scalable, robust, high availability, communication network using multiple spot-beam satellites (multi-satellite), as opposed to a single large spot-beam satellite. It will be shown that the multi-satellite approach overcomes many of the limitations of conventional approaches.

### SUMMARY OF THE INVENTION

To meet these and other objectives, the present invention provides for a scalable multi-satellite spot-beam system architecture and communication method that employ a plurality (N) of relatively small (low power), active, spot-beam satellites and a number (R) of spare spot beam satellites, all of which are substantially collocated at a given orbital location to provide coverage of a desired geographic area. The plurality of active and spare spot beam satellites are employed instead of a single large satellite as is done conventionally.

The satellites are arranged in an N+R:N configuration (also referred to as an N+R for N redundant configuration). Each satellite is similar or substantially identical in design. Each active satellite has approximately 1/N of the total capacity (e.g., 10 Gbps/N for the example discussed in the Background section). Each of the spare satellites can provide full or partial protection for each of the active satellites, and up to “R” total satellite failures could be tolerated without losing any capacity at the orbital slot.

User terminals (users), located in any of the spot beams, communicate with each other via satellites and gateways of the system. The space segment portion of the network is scalable in that the initial service from a particular orbital location over the full coverage area may be provided using only a few (perhaps two) of the N satellites. Later, the capacity from the orbital location can be increased by deploying additional satellites. With this approach, a much lower initial capital investment is required to initiate service, and subsequent investments in additional capacity (i.e. additional satellites and gateways) can be timed to match the market demand.

### BRIEF DESCRIPTION OF THE DRAWINGS

The various features and advantages of the present invention may be more readily understood with reference to the following detailed description taken in conjunction with the accompanying drawings, in which:

FIG. 1 depicts an exemplary multi-satellite spot beam implementation of an architecture of a scalable geostationary satellite system in accordance with the present invention, where there are 4 active and 2 spare satellites and either of the two spare satellites can be interchanged with any of the active satellites;

FIGS. 2 and 3 illustrate the concepts of the forward and return links, respectively, with the total available user beam forward and return spectrum divided among 4 beams (also referred to as a “4-color” system) in accordance with the principles of the present invention;

FIG. 4 depicts an exemplary beam plan for a multi-satellite constellation at a single orbital location;

FIGS. 5 through 8 illustrate general (FIGS. 5 and 7) and exemplary (FIGS. 6 and 8) frequency plans for the forward and return links in accordance with the principles of the present invention;

FIG. 9 shows a general beam plan for a multi-satellite constellation at a single orbital slot;

FIG. 10 illustrates a beam plan example in which the individual satellites cover a single row of beams;

FIG. 11 illustrates a beam plan example for a 4-color system in which the individual satellites cover a single row of beams;

FIGS. 12 and 13 depict two examples of interchangeability among individual satellites of a multi-satellite constellation in accordance with the principles of the present invention;

FIG. 14 contains an example beam plan for a 9-satellite constellation in which the individual satellites provide a 16-beam cluster;

FIG. 15 contains an example beam plan for a 9-satellite constellation in which the individual satellites provide coverage for 16 discontinuous cells;

FIG. 16 illustrates the coverage of a single satellite used in the 9-satellite constellation of FIG. 15;

FIG. 17 depicts how a combination of spacecraft attitude modification, adjustment in the spot beam frequencies, and spacecraft antenna reconfiguration can be used to obtain interchangeable satellites;

FIG. 18 illustrates the concept of sub-channelization for the general beam plan of a multi-satellite constellation at a single orbital slot;

FIG. 19 illustrates the concept of sub-channelization for the individual satellites of a multi-satellite constellation in accordance with the principle of the present invention; and

FIG. 20 is a flow diagram illustrating an exemplary communication method in accordance with the principle of the present invention.

### DETAILED DESCRIPTION

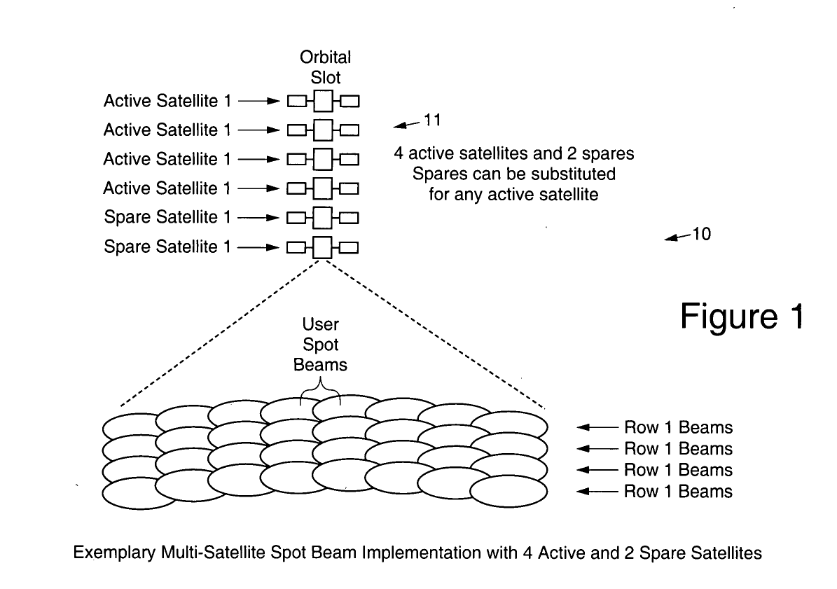

Referring to the drawings, FIG. 1 depicts an example of a multi-satellite 11 spot beam implementation of an architecture of a scalable geostationary satellite system 10 in accordance with the present invention. As is shown in FIG. 1, there are 4 active and 2 spare satellites 11 and either of the two spare satellites 11 can be interchanged with any of the active satellites 11.

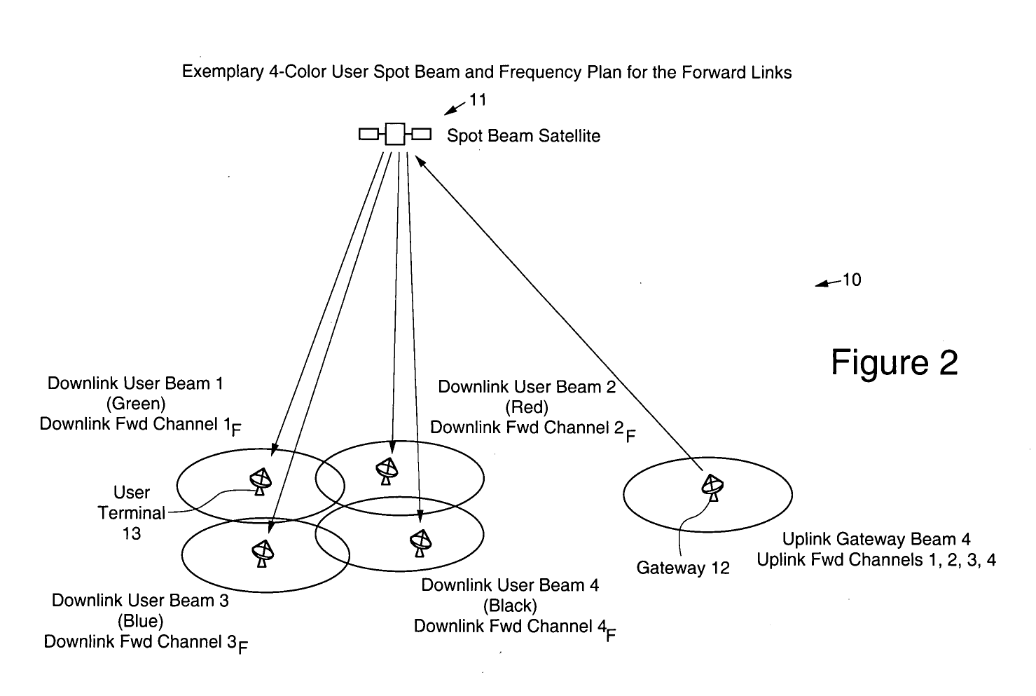

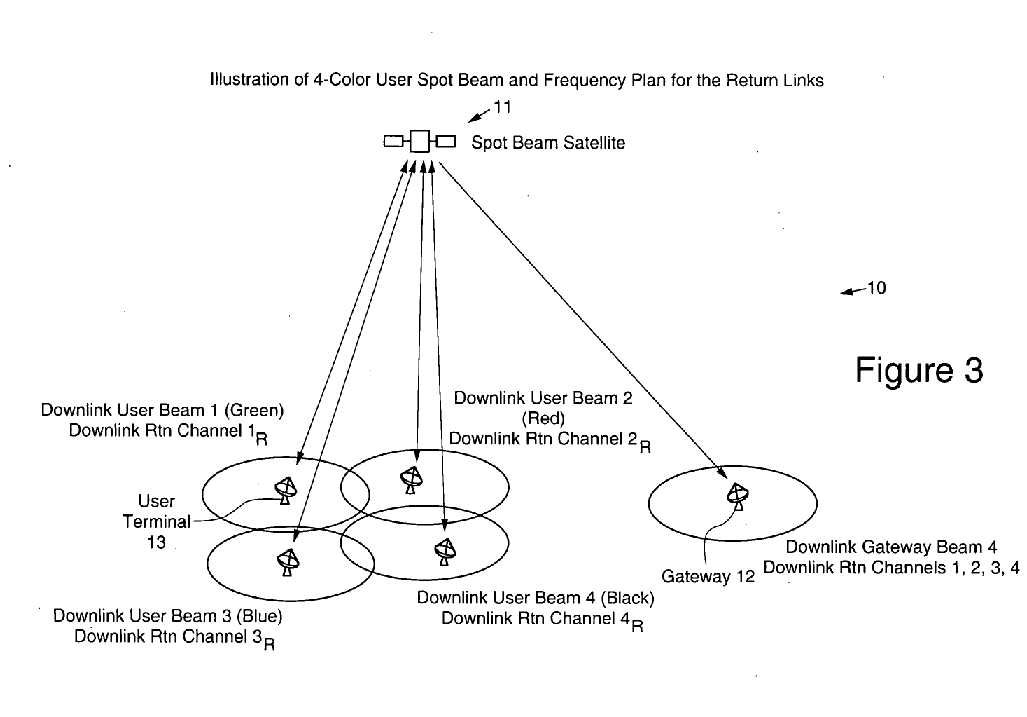

FIGS. 2 and 3 illustrate some of the general communications principles for a network, employing an access satellite 11. The forward link, also referred to as the forward channel, is used for communications FROM the gateways 12 TO the user terminals 13. In the forward communications channel, the gateway 12 would transmit to the satellite 11, via an uplink gateway beam, using the uplink frequencies allocated to the forward link, and the communications signals would be transmitted from the satellite 11 to the user terminals 13 in a downlink user beam, using the downlink frequencies allocated to the forward link. The return link, also referred to as the return channel, is used for communications in the opposite direction, namely FROM the user terminals 13 TO the gateways 12. In the return communications channel, the user terminal 13 would transmit to the satellite 11, via an uplink user beam, using the uplink frequencies allocated to the return link, and the communications signals would be transmitted from the satellite 11 to the gateways 12, using the downlink frequencies allocated to the return link.

FIG. 2 also shows one example of how the downlink spectrum for the forward links can be partitioned among a set of downlink user spot beams. In this example the downlink forward channel bandwidth has been partitioned into 4 separate and distinct channels, 1_{F}, 2_{F}, 3_{F}, and 4_{F}, with each channel allocated to a separate downlink user spot beam, which has its own “color”. The subscript “F” denotes that the channel is for the forward link. Though not necessary, in general, equal bandwidth segments would be used for each of the downlink channels, so in this example the bandwidth of in each beam, BW_{Fwd}_{_{—}}_{Chann}, is equal to one quarter of the total available downlink user beam spectrum or_*BW_{Fwd}_{_{—}}_{Total}_{_{—}}_{User}_{_{—}}_{Beam}. Since the available user beam bandwidth is distributed among 4 beams and each beam has its own color, this type of frequency partitioning is refer to as a “4-color” system 10, and a set of four user spot beams is called a “super-cell.” In general, the 4 beams would be adjacent, but there will most likely be instances where one or more of the beams in some super-cells will not be touching any of the other beams in the super-cell. Other frequency partitioning arrangements are possible. The available downlink user beam spectrum could have been divided into L_{F} segments where L_{F} could equal 2, 3, 5, 6, 7, or more segments to obtain a 2-, 3-, 5-, 6-, 7- or more color system 10 (i.e. the beam plan would be a L_{F}-color system 10) and the concepts of the scalable multi-satellite spot beam architecture would still be identical. It is important to note that though the depiction in FIG. 2 shows that the uplink gateway beam for the forward links covers an area different from the user beams, it is possible and, perhaps even likely, that the uplink gateway beam would be geographically coincident with one of the downlink user beams.

The individual frequency segments or channels in each beam could themselves be partitioned into multiple sub-channels, and it will be discussed later how this partitioning can be exploited to obtain a scalable system 10—that is, a system 10 whose capacity can be increased to match a commensurate increase in demand. The preceding paragraph described how forward link spectrum is assigned to the downlink user beams. The principles can be applied, as well, to the uplink user beams for the return links, which occupy the available user beam uplink frequency range. Continuing the example from the preceding paragraph, the return link uplink spectrum, BW_{Rin}_{_{—}}_{Total}_{_{—}}_{User}_{_{—}}_{Beam} is partitioned into 4 separate and distinct segments, where each segment is allocated to an uplink spot beam, as shown in FIG. 3. FIG. 3 shows that each user spot beam has its own color, and since 4 colors are used, the beam and frequency plan for the return channel is also a 4-color system. Four distinct colored beams form a super-cell, and though it is likely that the beams in a super-cell will be adjacent to one another, it is not necessary. The uplink user beam spectrum could have been partitioned into L_{R} segments where L_{R} could equal 2, 3, 5, 6, 7, or more segments, and the scalable multi-satellite spot beam concepts would remain unchanged. It is important to note that though the depiction in FIG. 3 shows that the downlink gateway beam for the return channels covers an area different from the user beams, it is possible and, perhaps even likely, that the gateway beam would be geographically coincident with one of the uplink user beams.

The primary reason for partitioning the available user beam downlink and uplink bandwidth into smaller segments and using a multi-color system 10 is to obtain frequency re-use with tolerable interference levels. If adjacent spot beams were to use the same segment of downlink (or uplink) frequency, the interference levels would be so high that the communications would be drastically impaired. (Note: The case of singly polarized user spot beams is being considered. In the case of dual polarization, there are 2 methods that can be used to obtain additional frequency re-use. In the first method, the each spot beam would employ dual polarization and the same frequency segment would be used in each polarization. In the second method, adjacent beams would be oppositely polarized and the same frequency segment would be used in the adjacent beams. However, with current technology, it is not clear that there would be sufficient polarization and spatial isolation to provide acceptable interference levels for either of these frequency re-use methods.) Frequency re-use is obtained by replicating the super-cell multi-color pattern across the desired coverage region, and the level of frequency re-use is determined by the number of instances each color is used in the desired coverage region.

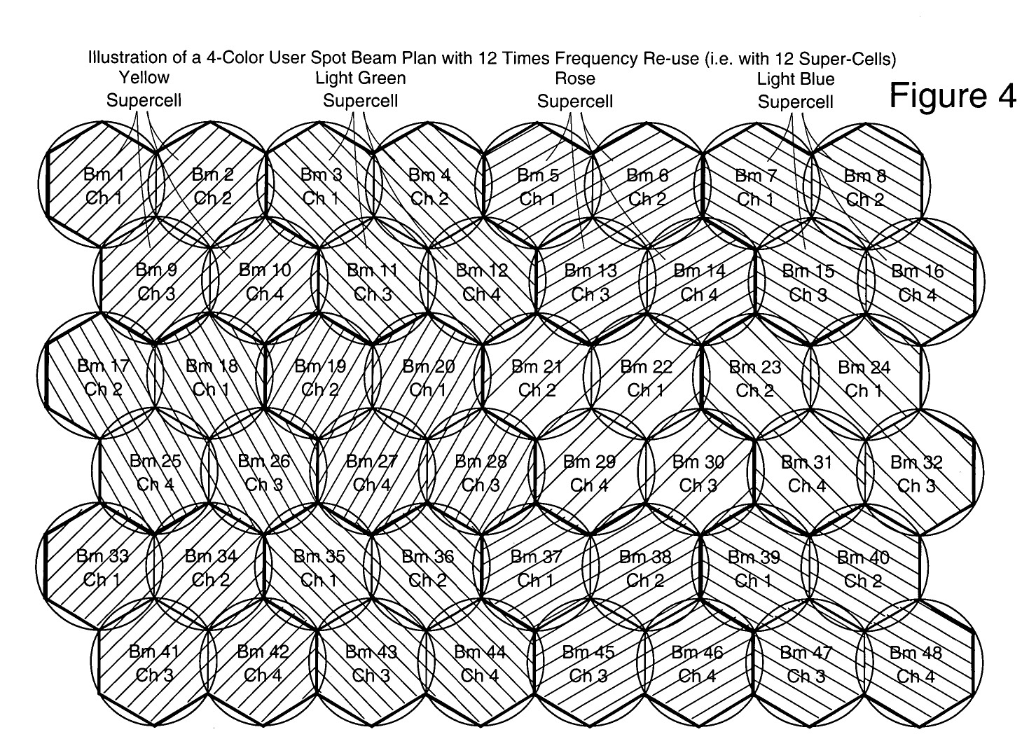

FIG. 4 illustrates a sample beam plan for a 48-beam, 4-color spot beam system 10 over an extended coverage area. The four colors for the beams (or outlines indicating the edge of the circular beams) correspond to green, red, blue, and black, for example, which are associated with channels 1, 2, 3, and 4, respectively. Also shown in FIG. 4 are super-cells designated with 45° left hatching, 45° right hatching, 120° left hatching, and 120° right hatching, respectively. Twelve super-cells are shown in FIG. 4.

One of the super-cells is outlined with a bold line for clarity. A set of four beams make up a super-cell, the super-cells are indicated by the hatched (colored) regions, and in the example depicted in FIG. 4, there are 12 super cells, which means that there is 12 times frequency re-use of the user beam spectrum. There is no special meaning for the color selection of the super-cells; the various “colors” were chosen only to make the individual super-cells appear distinct. In the regions where multiple beams overlap, although any of the overlapping beams could be used to serve the user terminal, 13 one would generally expect the terminal 13 to use the beam whose beam center is closest to the terminal 13.

The amounts of available uplink and downlink gateway spectrum, the use of single or dual-polarization gateway beams, plus the level of user beam frequency re-use determine the number of required gateways 12. ITU regulations and the frequency allocation policies of individual countries determine the available uplink and downlink gateway spectrum. Herein, frequency plans are considered that employ single polarization gateway beams. However, it is important to note that dual-polarization gateway beams are possible, especially if the gateway locations are close to the beam center of the gateway beams, since near the beam center the cross-polarization isolation of the gateway beams is generally adequate, and the spatial isolation from nearby co-polarized gateway beams is also adequate. The extent of the frequency re-use depends on the beam size, the extent of the coverage area, and the “color scheme”—that is, whether the system 10 is a 2-, 3-, 4-, or L_{F} (or L_{R})-color system 10.

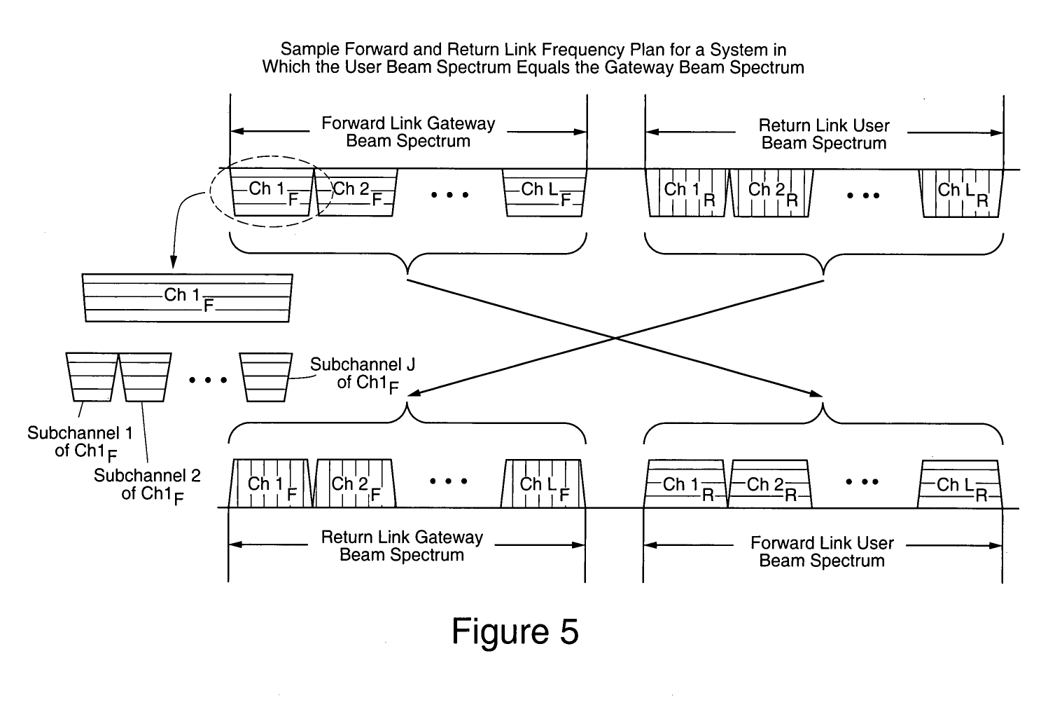

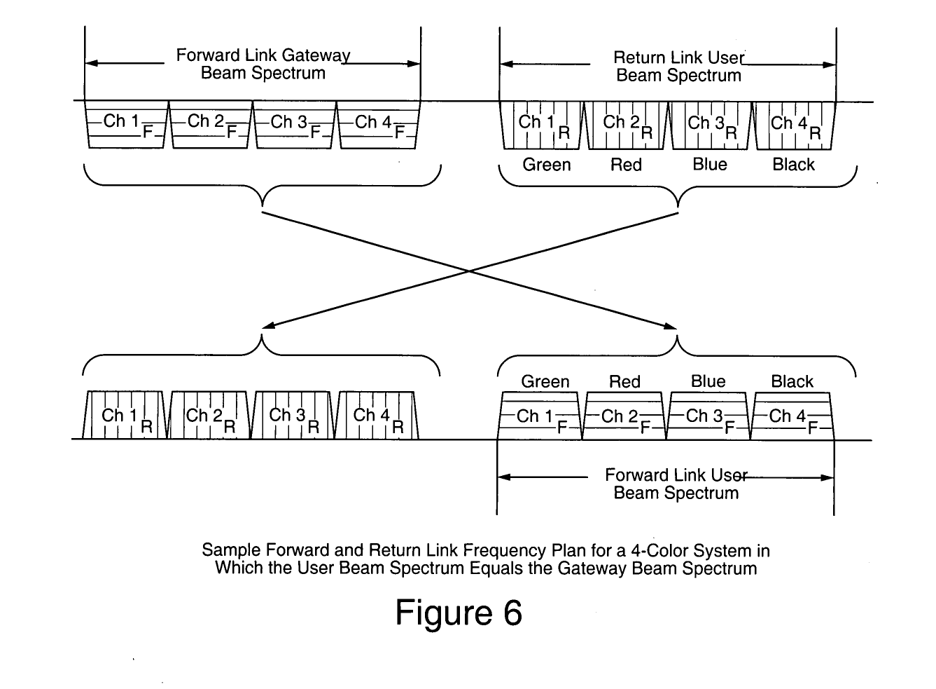

FIG. 5 depicts a frequency plan for a system 10 in which the uplink and downlink user beam bandwidth equals the uplink and downlink gateway beam bandwidth. In this type of system 10 there will be 1 gateway 12 for each super cell, where the super cells are made up of L_{F} and L_{R} distinct colors for the forward and return links, respectively. FIG. 5 also shows that channel 1_{F} is divided into an arbitrary number, J, of sub-channels. The remaining forward and return channels are similarly subdivided but the partitioning is not shown in the figure, because there is insufficient space on the page. Later in this description, it will be shown how the sub-channelization contributes to the scalability aspects of the system 10. FIG. 6 contains a frequency plan depiction of the forward and return links for a 4-color system 10 (L_{F} and L_{R} equal 4), so there would be a gateway 12 for each set of 4 user beams, since 4 distinct colors form a super cell. The channels in the individual beams would be partitioned into sub-channels, though the sub-channelization is not depicted because of insufficient space on the page.

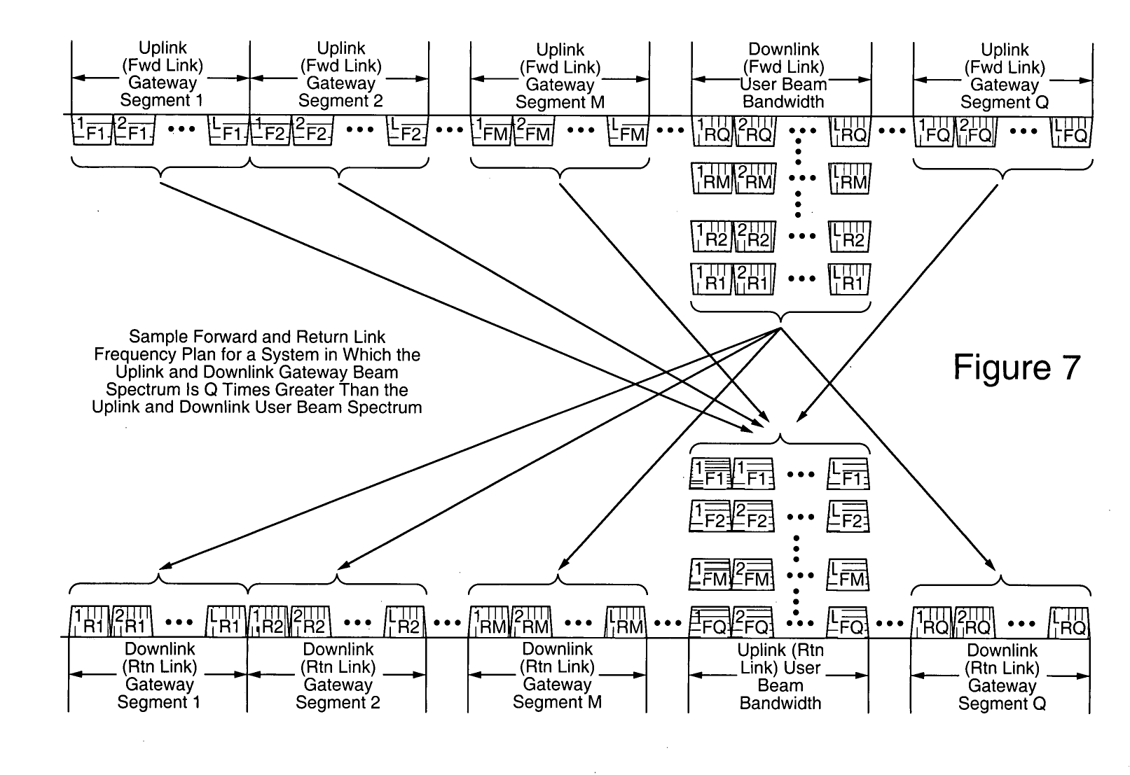

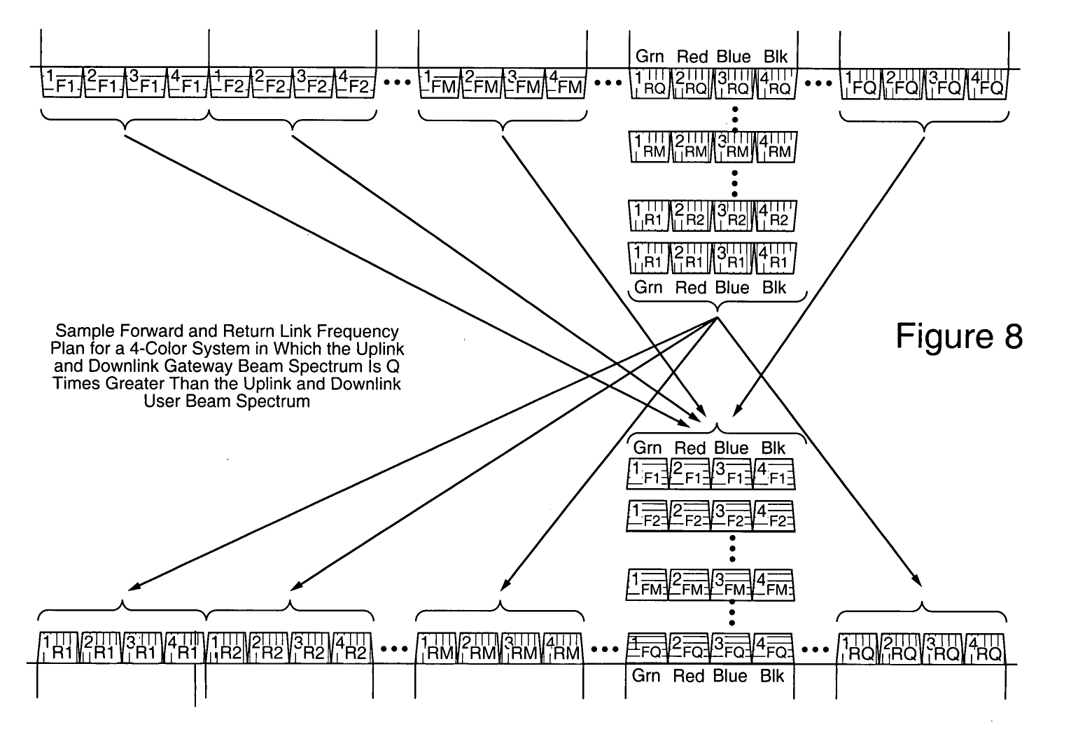

FIG. 7 depicts a more general frequency plan in which the available uplink and downlink gateway beam spectrum is Q times larger than the downlink and uplink user beam spectrum. If all of the available (gateway) spectrum were utilized at each gateway 12, each gateway 12 could power Q super cells (i.e. there would be Q times frequency re-use of the user beam spectrum for each gateway 12), where the super cells are made up of L_{F} and L_{R} distinct colors for the forward and return links, respectively, if 1 channel per beam is permitted. The frequency plan for a 4-color system 10 is depicted in FIG. 8, and it shows that a single gateway 12 could be used to operate 4*Q user beams. As in the frequency plans illustrated in FIGS. 5 and 6, the individual channels are partitioned into sub-channels, though the sub-channelization is not depicted in FIGS. 7 and 8 because of insufficient space on the page.

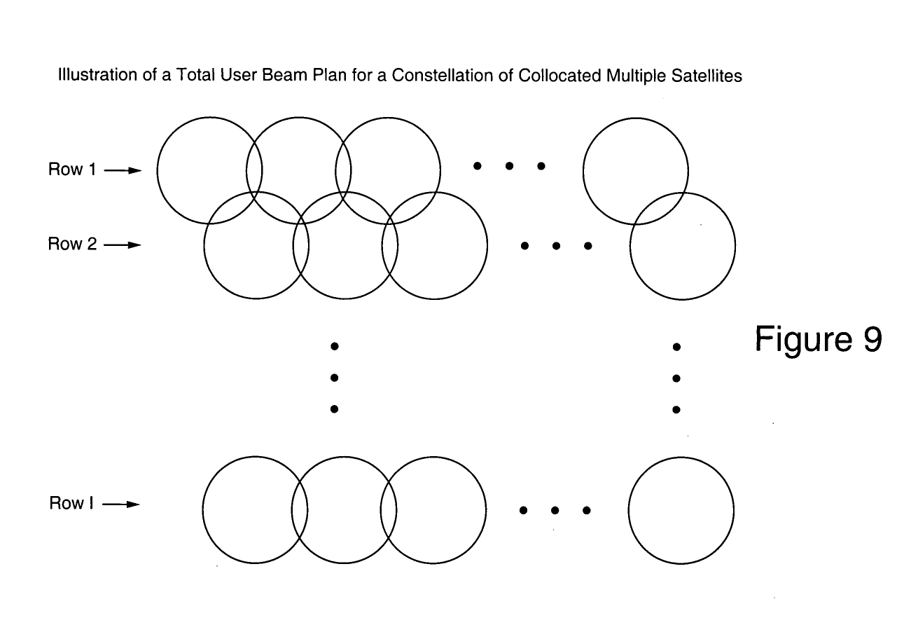

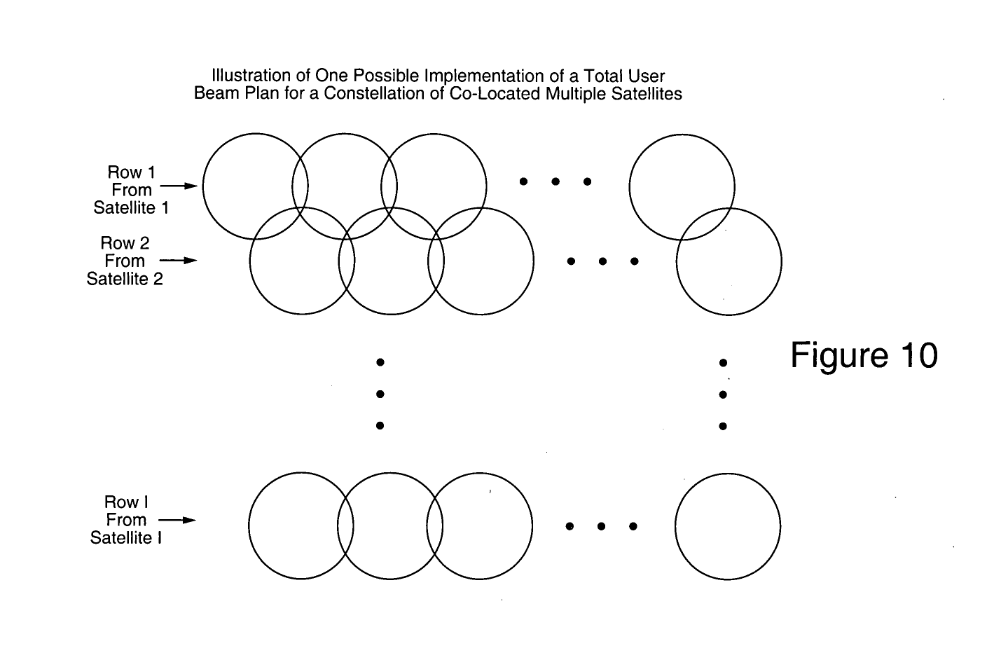

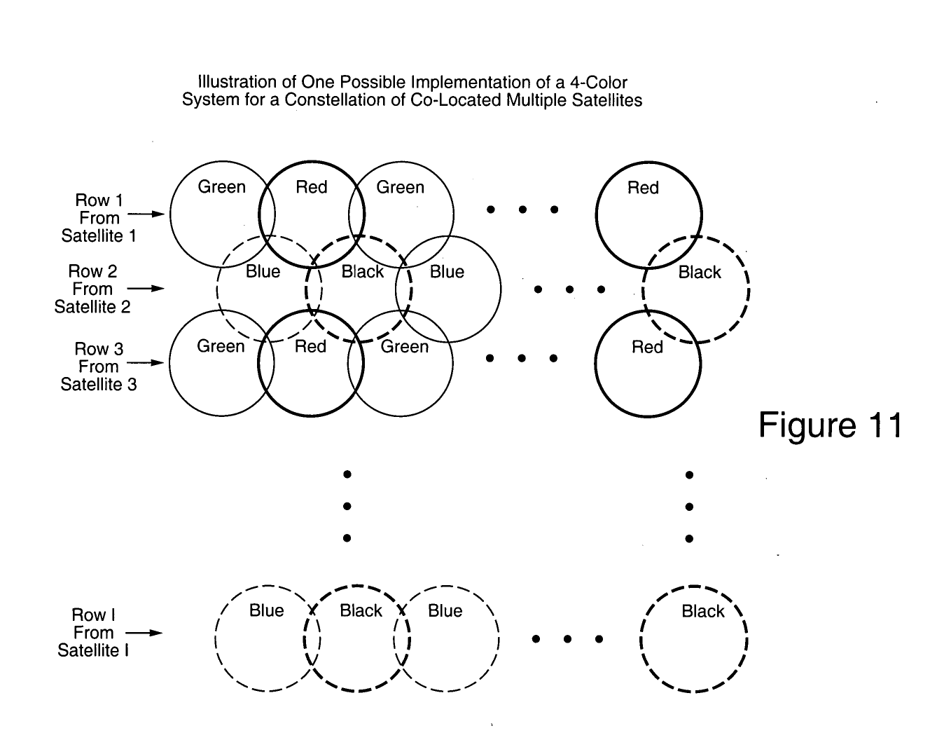

The forward and return links, spot beam plans and L_{F} and L_{R} color systems, frequency plans (including sub-channelization) and frequency re-use, and the idea of multiple satellites 11 have been discussed. Now, all of these concepts will be pulled together to show the architecture of a constellation of multiple spot beam satellites 11 and its powerful advantages. A general user beam plan is the starting point, illustrated in FIG. 9 and showing beams in “I” rows. The subscript “i” will be used to denote the “ith row”. FIG. 9 shows the total user beam plan arising from deployment of “N” active satellites 11; the beam plans for the individual satellites 11 will be a subset of the total user beam plan, and in one possible implementation of the present invention, displayed in FIG. 10, the individual satellites 11 provide coverage for a single row of beams, so satellite 1 provides the first row of beams, satellite 2 provides the second row of beams, and so on; satellite I provides coverage for row I, so in this specific implementation, in which there is one sub-channel per channel, the number of active satellites 11, N, equals the number of rows of beams, I (i.e. N=I). The designs of the individual satellites 11 are very similar, and in a 4-color system 10, the user beam frequency plans for every other row of satellites 11 would be identical, as shown in FIG. 11. Although not depicted, the frequency spectrum in each beam is partitioned into sub-channels.

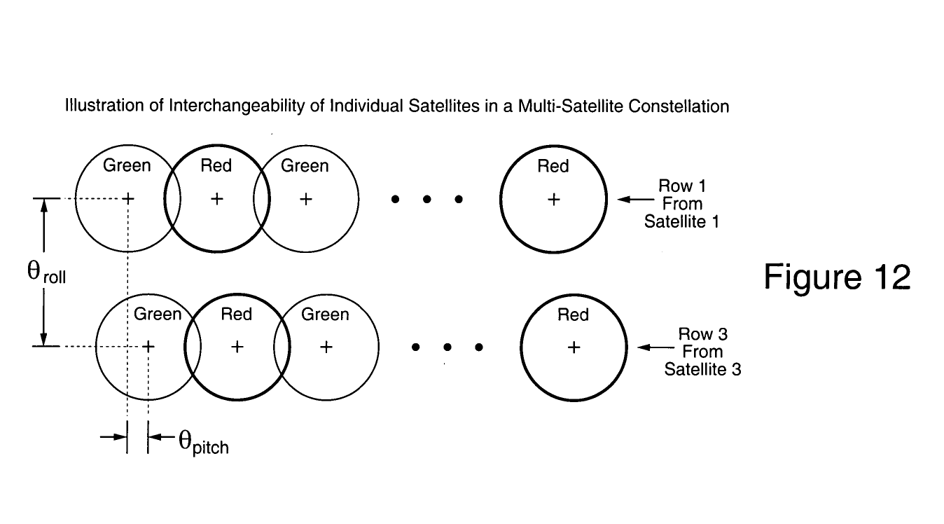

Satellites 11 from every other row are like-frequency satellites 11 and may be oppositely polarized to reduce interference, so for instance beams in rows 1, 5, 9, etc., would employ right hand circular polarization (RHCP), while beams in rows 3, 7, 11, etc would employ left hand circular polarization (LHCP). Continuing with the example, if the capability of polarization selection is added to the beams, a huge benefit is obtained, namely interchangeability of the like-frequency satellites 11 by adjusting the attitude of the satellite 11 (pitch and roll), as shown in FIG. 12. FIG. 12 shows that by adjusting the satellite roll and pitch by θᵣₒₗₗ and θ_{pitch}, respectively, satellite 1 can be “aimed” to provide coverage of the row 3 beams. The same effect is accomplished by electronically (in the case of a phased array antenna) or mechanically steering the beams in pitch and roll by the same amount or by activating the appropriate feeds in a multi-feed satellite antenna. The entire satellite 11 could also be pointed, the beams steered, or the appropriate transmit antenna feeds activated to provide coverage of the row 5 beams or row 7 beams, etc (not shown in the figure). In fact, a spare satellite 11 or multiple spare satellites 11 would be deployed at the orbital location, and in the event of a catastrophic failure in an active satellite 11, the spare would be activated, and with either an attitude (pitch and roll) adjustment or beam steering or activation of the appropriate antenna feeds (and appropriate receive and transmit frequencies), the spare satellite 11 would be made to cover the row of beams that were served by the active satellite 11 prior to its failure.

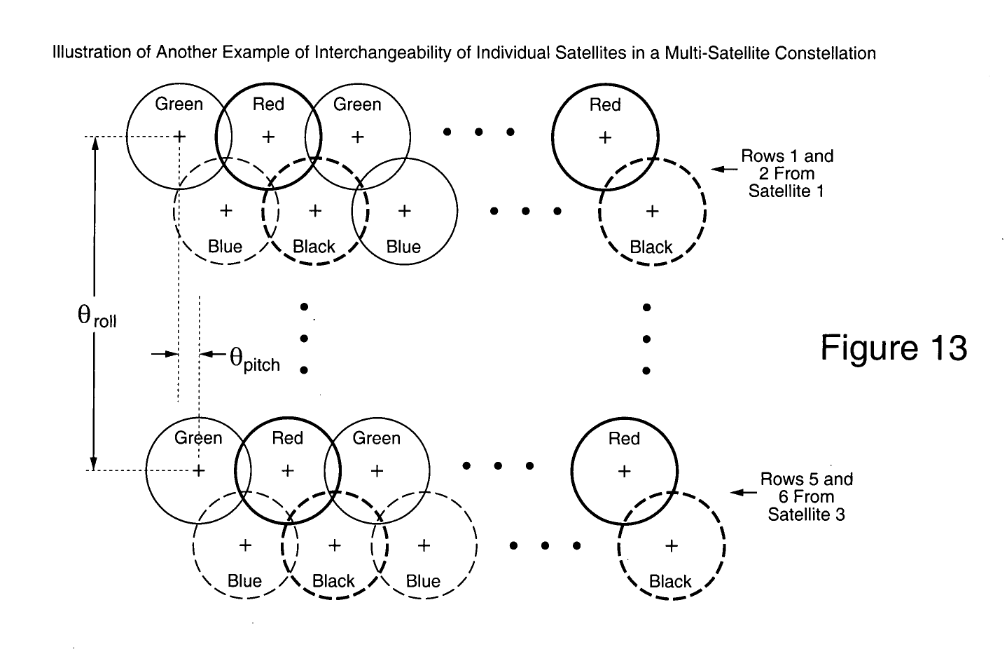

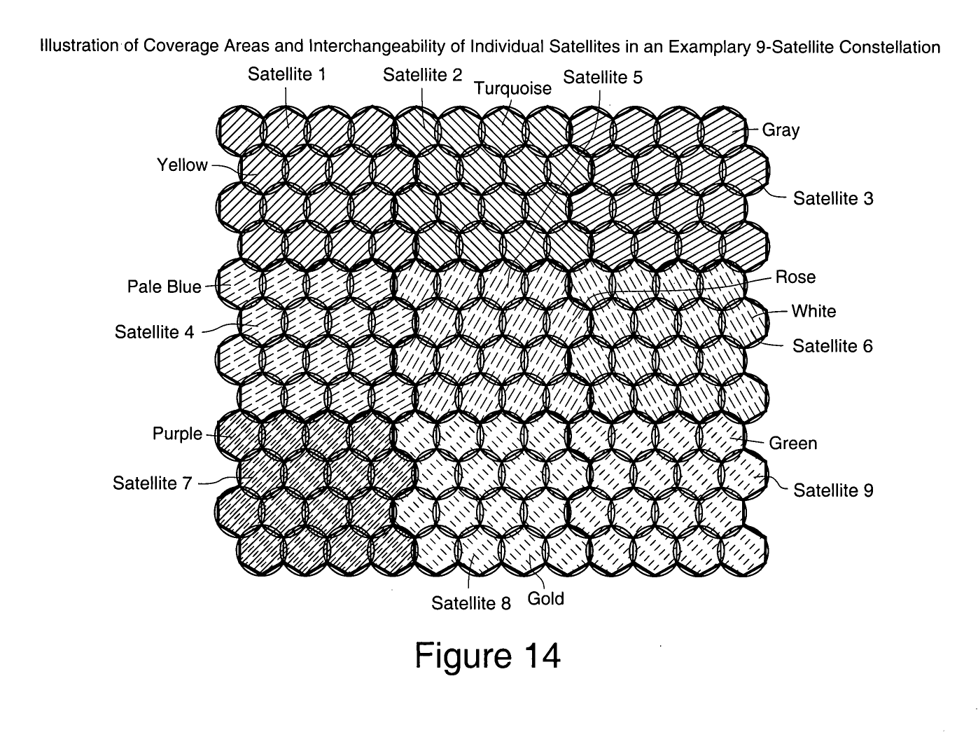

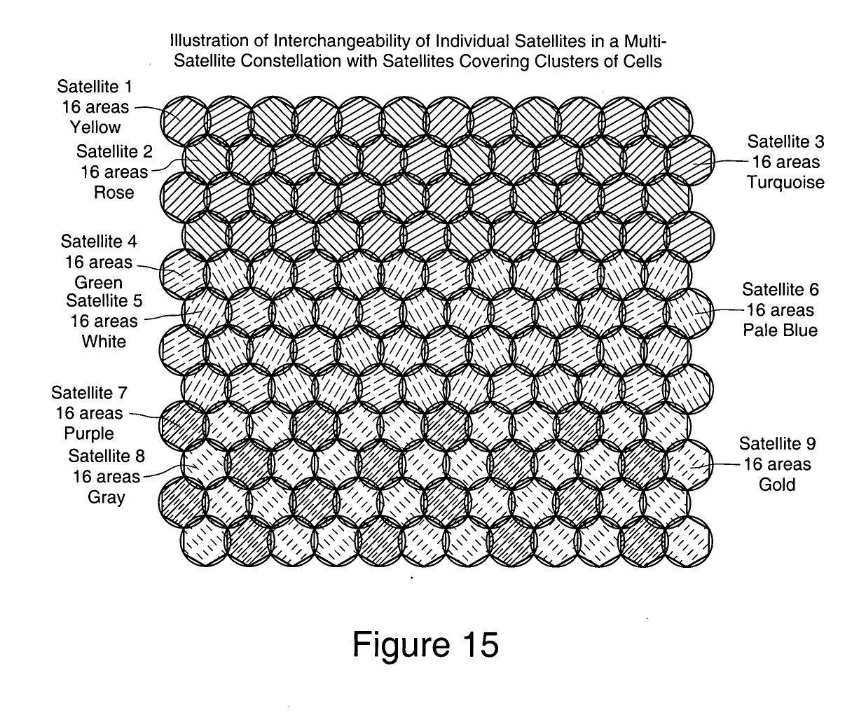

The preceding example considered the case where a single satellite 11 covers each row of beams, but the concept is not limited to this case. It could be that the satellites 11 are designed such that a single satellite covers multiple rows, as shown in FIG. 13, clusters of beams, as shown in FIG. 14, or even discontinuous sets of beams, as shown in FIG. 15.

FIG. 13 shows that with an attitude adjustment, beam steering, or activation of appropriate feeds in the satellite transmit antenna, satellite 1 could be made to cover the rows of beams of satellite 3 (and vice versa). In the case of I rows of beams, need I/2 active satellites 11 would then, be needed and the spare satellites 11 would also provide coverage of adjacent pairs of rows, so that if one of the active satellites 11 were to fail catastrophically, the spare could be brought on-line with the proper pitch and roll adjustment (or beam steering) to provide service for the rows of beams affected by the loss of the active satellite.

Still more scenarios, such as individual satellites 11 providing coverage of clusters of spot beams, an example of which is depicted in FIG. 14, are possible. The example depicted in FIG. 14 is for a 4-color beam plan containing 144 user spot beams, generated by 9 collocated active satellites 11, each of which supplies 16 beams. Recall that a “4-color” system 10 is one in which the available user beam spectrum is divided into 4 segments, each with its own distinct color. To distinguish the coverage areas of the individual satellites 11, distinct and separate colors having different cross-hatching in the drawing figures (and referred to as yellow, turquoise, gray, pale blue, rose, white, purple, gold, and green) are assigned to the areas covered by the each satellite 11. Note that there are nine colors, one for each satellite 11. In this example there is a high degree of interchangeability among the satellites 11, so the satellite 11 providing coverage for the yellow area, for instance, could provide coverage for any of the areas by either a spacecraft attitude adjustment or beam steering. Collocated spare satellites 11 with a similar design (i.e. 16 user spot beams with a 4-color beam plan) to the active satellites 11 could be made to cover any of the nine areas, so if one of the active satellites 11 were to fail, the spare could be brought on-line very quickly to restore service to the region originally by the failed satellite 11.

As in FIG. 14, FIG. 15 illustrates an example of a beam plan for a constellation of 9 collocated active satellites 11, each of which supplies 16 beams for a total of 144 user spot beams. And like the plan in FIG. 14, the plan in FIG. 15 is for a 4-color system 10 (note that the beam outlines are green, red, blue, or black for each color of the 4 color system). FIG. 15 differs from FIG. 14 in that the individual satellites 11 provide coverage of 16 separate and distinct areas or cells. There is an active satellite for the yellow cells, one for the turquoise cells, one for the gray cells, one for the pale blue cells, one for the rose cells, one for the white cells, one for the purple cells, one for the gold cells, and one for the green cells. The potential advantage of the implementation in FIG. 15 over that of FIG. 14 is in the mechanical design and packaging of the spacecraft antennas; in fact, fewer antennas may be required for each satellite 11 if the beam plan is implemented as depicted in FIG. 15.

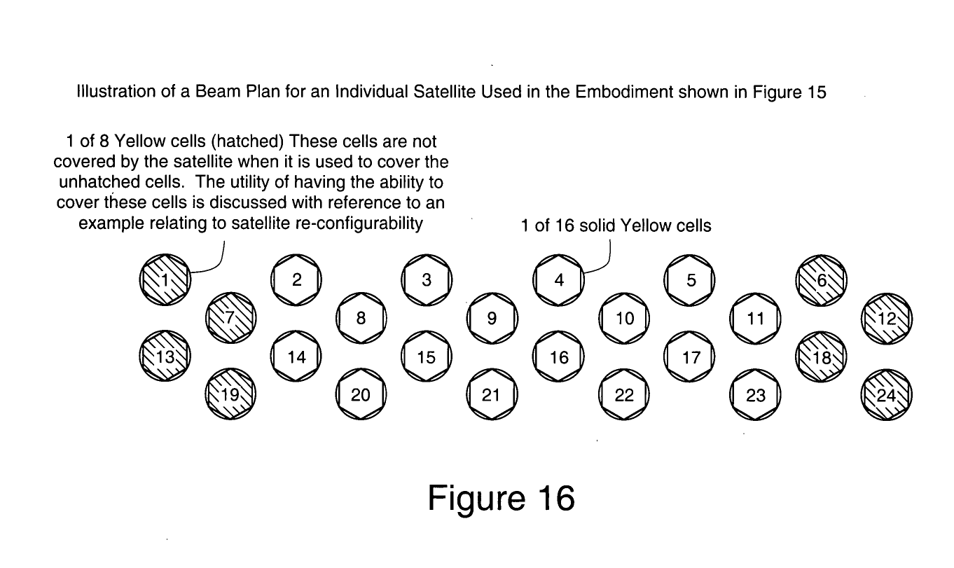

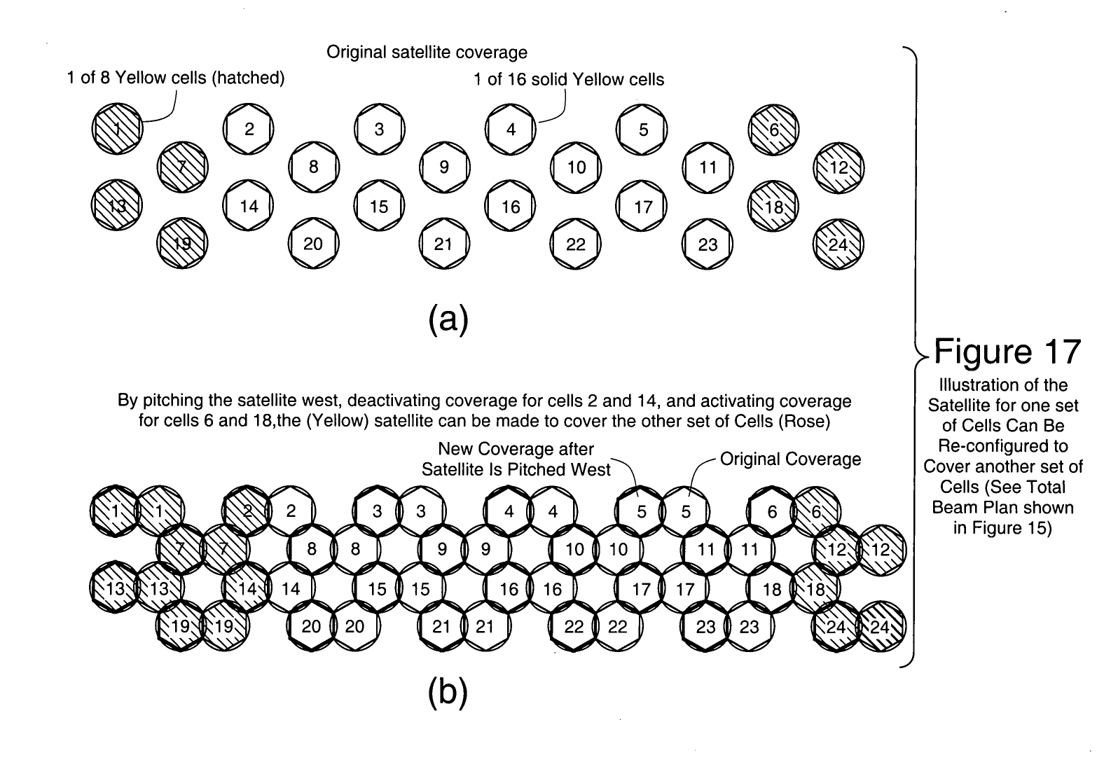

There is a high degree of similarity in the beam plans for the individual satellites 11 in FIG. 15. FIG. 16 shows the beam plan for one of the satellites 11. FIG. 16 depicts 16 solid yellow cells and 8 yellow cells with diagonal black lines. If this satellite 11 were to be used as the “yellow satellite,” that is, a satellite covering the 16 solid yellow cells depicted in FIG. 15, the satellite 11 would be configured—possibly by activating the appropriate feed elements in the antenna and/or adjustment of the satellite attitude—to provide coverage for cells 2, 3, 4, 5, 8, 9, 10, 11, 14, 15, 16, 17, 20, 21, 22, and 23. Cells 1, 6, 7, 12, 13, 18, 19, and 24 would not be covered, since they are not part of the total coverage area depicted in FIG. 15. However, if the “yellow” coverage satellite 11 were to be used to cover the rose cells depicted in FIG. 15, the satellite 11 would be re-configured, possibly by deactivating some of the feed elements (the feed elements for cells 2 and 14), activating other feed elements (the elements for cells 6 and 18), changing the downlink channels in the feed elements (for instance, the feed element for cell 3 would be fed with the “green” downlink channel instead of the “red” downlink channel), and pitching the satellite 11 west by about one cell diameter. Upon implementation of these changes, which are depicted in FIG. 17, the “yellow” satellite 11 would become the rose colored satellite 11.

Whatever the design for the individual satellites 11, one of the key features of the multi-satellite concept is the utilization of many relatively small, interchangeable (to a high degree) satellites 11, so in the event of a catastrophic failure of one (or more) of the satellites 11, only a portion of the coverage area is affected, and spare capacity can be brought on-line to prevent a long-term service outage for any of the users.

This approach to providing spare capacity has huge advantages to the conventional approach of launching a very large satellite, which provides all the coverage and capacity. With the large satellite approach, in the event of a catastrophic satellite failure, the replacement satellite would also have to be a large (probably duplicate) satellite. To prevent a lengthy service outage, the backup satellite would have to be launched at around the same time as the primary satellite and flown “dark” (i.e. with no channels operating). In this scenario, the orbital location is populated with twice the usable satellite capacity, and with ½ of the total capacity active. This is an extremely expensive way to obtain backup capacity. To make the system 10 tolerant of 1 satellite failure, the space segment costs are about double the cost of a single satellite plus launch, and to make the system 10 tolerant to 2 satellite failures, 2 backup satellites 11 would be required, making the space segment costs about three times the cost of the primary satellite and its launch. With the small (or relatively small) satellite approach, the cost of the spare capacity can be smaller than or on par with the cost of the active portion of the space segment, and a very high degree of robustness is obtained, since up to R catastrophic satellite failures can be tolerated.

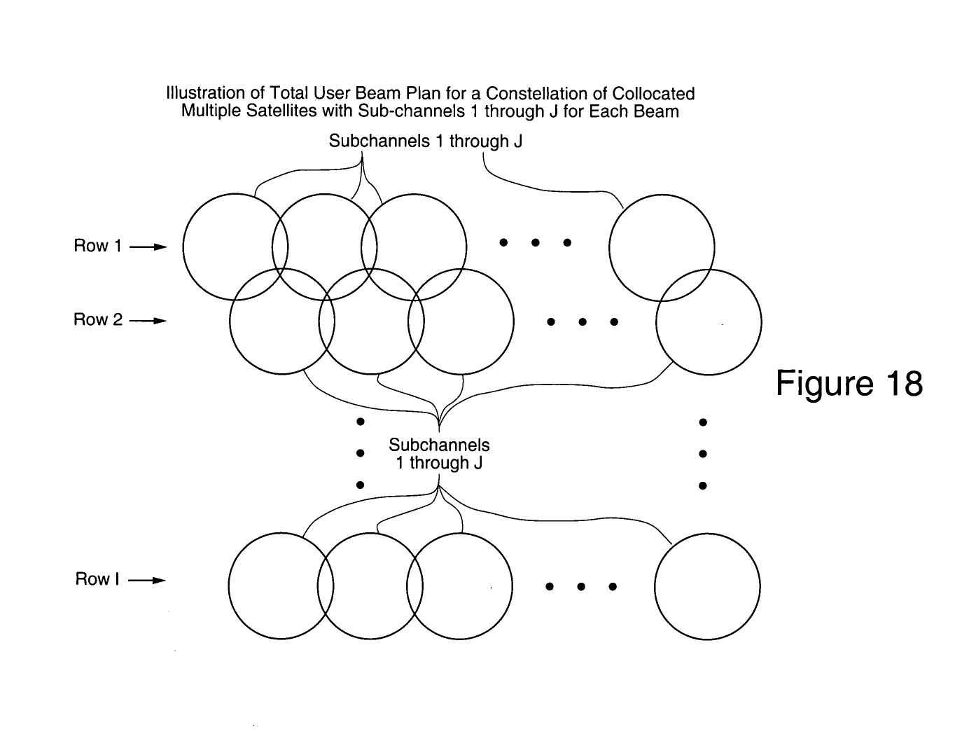

The interchangeability aspect of the present invention has been discussed, and how to make the architecture scalable will now be discussed, that is how to add capacity when it is needed. There are two ways to add capacity. The first way is to add rows of beams to expand the service area, and the second way is to provide additional spectrum for the individual cells. It has previously been stated that the frequency spectrum in the individual user beams would be partitioned into sub-channels, which could have bandwidth of a few MHz to 50 MHz or more. FIG. 18 illustrates the general beam plan with the sub-channelization of the individual beams. It is important to remember that the available user beam spectrum is divided among a group of L_{F} and L_{R} beams to form an L_{F}- and L_{R}-color system 10. The spectrum for each of the beams in a super-cell, having L_{F} and L_{R} beams, is divided into the sub-channels. Adjacent beams do not employ the same frequency segment (i.e., sub-channel 1 in one beam and sub-channel 1 in an adjacent beam operate over different frequency segments), because of excessively high interference levels.

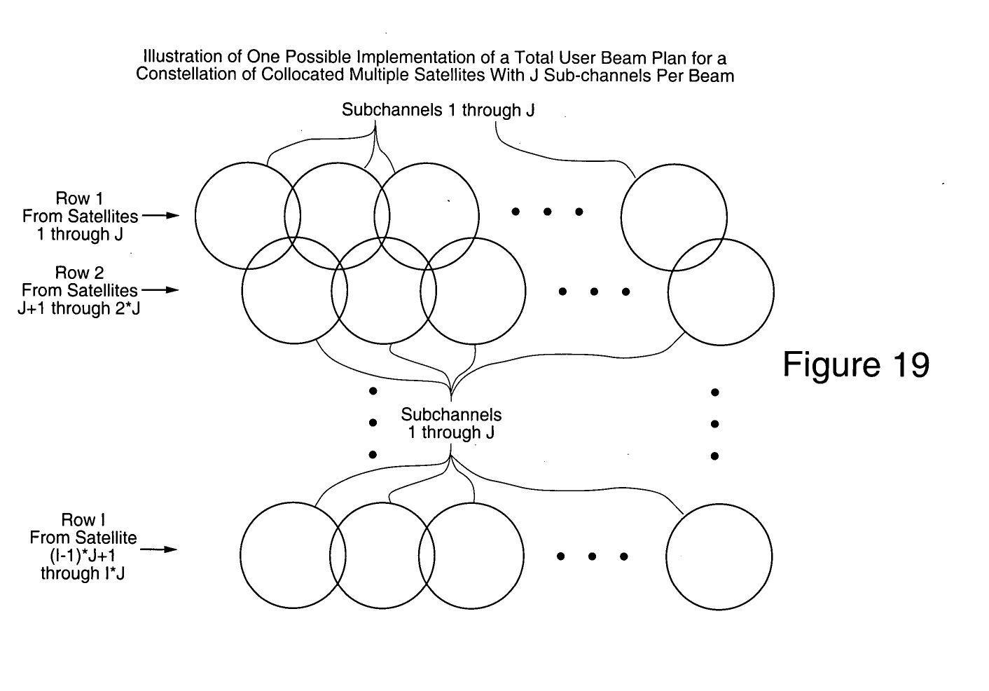

In a preceding example (see FIG. 10), a system 10 was considered where each row of beams was provided by a single satellite 11, with N active satellites 11 and I rows of beams, so N=I. Suppose the spectrum in each of the individual beams is partitioned into J sub-channels and suppose that each of the individual satellites 11 covers a row of beams and that there is only one sub-channel in each beam, as depicted in FIG. 19. Each satellite 11 by itself supplies 1/J of the total available capacity for each row, and J satellites 11 are needed for each row to provide all of the available capacity. The total number of active satellites 11, N, would be J*I, when all of the available capacity is deployed, and in this example, I satellites 11 (1 satellite 11 for each row of beams) are needed to start the service for the entire coverage region, so the space segment costs for service introduction can be smaller than the cost to provide the total available capacity. As capacity is utilized, additional capacity could be launched into the slot to meet the increased demand by launching satellites 11, which operate in the un-utilized sub-channels. Tailoring of capacity to meet market demand can have a huge impact on the profitability of the system 10, since deployment costs can be more closely matched to actual revenue growth, especially in comparison to the approach of launching a very large satellite or the full constellation of satellites 11, which provide the full coverage and capacity. If the satellites 11 are designed to be frequency agile (i.e. operate over different sets of sub-channels), spare capacity can be deployed easily.

The principles in the preceding paragraph are applicable if the individual satellites 11 are designed to cover one adjacent pair of rows, as indicated in FIG. 13, clusters of cells, as indicated in FIG. 14, or discontinuous cells, as depicted in FIG. 15.

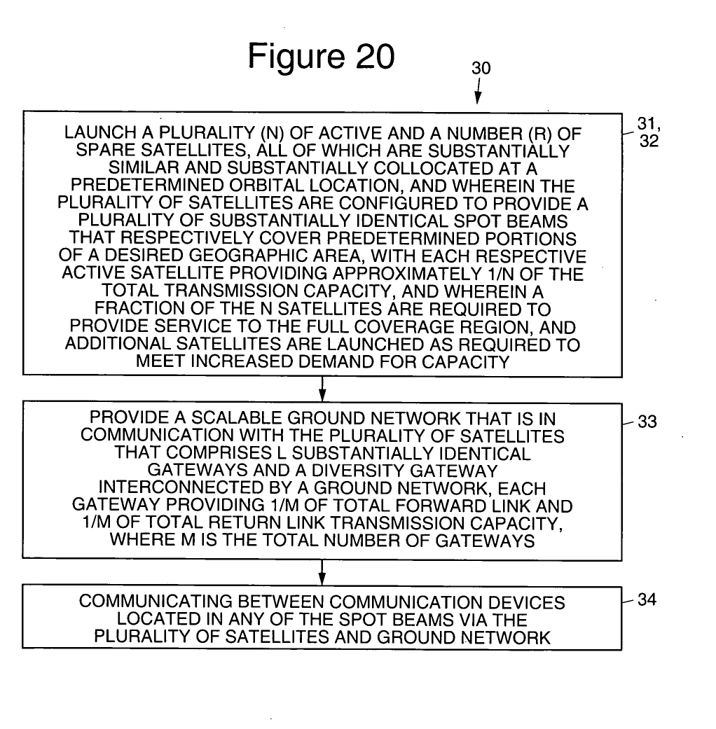

For the purposes of completeness, FIG. 20 is a flow diagram that illustrates an exemplary communication method 30 in accordance with the principles of the present invention. The exemplary communication method 30 comprises the following steps.

A plurality (N) of active and a number (R) of spare satellites 11 are launched 31, all of which are substantially similar, interchangeable to a high degree, and substantially collocated at a predetermined orbital location. The plurality of satellites 11 are configured 32 to provide a plurality of substantially identical spot beams that respectively cover predetermined portions of a desired geographic area, with each respective active satellite 11 providing approximately 1/N of the total transmission capacity. A fraction (subset) of the N satellites 11 provide service to the full coverage region, and additional satellites 11 are launched as required to meet increased demand for capacity.

A scalable ground network is provided 33 that is in communication with the plurality of satellites 11 and that comprises L substantially identical gateways 12 and a diversity gateway 12 interconnected by a ground network, each gateway 12 providing 1/M of total forward link and 1/M of total return link transmission capacity, where M is the total number of gateways 12. Communication devices located in any of the user spot beams communicate 34 via the plurality of satellites 11 and ground network.

Thus, a scalable network using multiple spot-beam satellites has been disclosed. It is to be understood that the described embodiments are merely illustrative of some of the many specific embodiments, which represent applications of the principles of the present invention. Clearly, numerous and other arrangements can be readily devised by those skilled in the art without departing from the scope of the invention.

1. A scalable geostationary satellite system architecture comprising:
a plurality (N) of active and a number (R) of spare satellites, all of which are substantially similar and substantially collocated at a predetermined orbital location, each active satellite providing a plurality of substantially identical spot beams that respectively cover predetermined portions of a desired geographic area, with each respective active satellite providing approximately 1/N of the total transmission capacity of the system architecture.

2. The system architecture recited in claim 1 wherein the coverage of the individual satellites is adjustable by modifying the satellite attitude (pitch and roll) and/or satellite antenna reconfigurations to provide coverage of any of the remaining satellites.

3. The system architecture recited in claim 1 wherein the coverage of the individual satellites is adjustable by beam steering to provide coverage of any of the remaining satellites.

4. The system architecture recited in claim 1 wherein the frequencies used in downlink and uplink user spot beams is adjustable.

5. The system architecture recited in claim 1 wherein a fraction of the active N satellites is required to provide capacity to the full desired geographic coverage area.

6. The system architecture recited in claim 1 wherein the spot beams are generally arranged as East-West rows of beams.

7. The system architecture recited in claim 1 wherein the spot beams are generally arranged as North-South columns of beams.

8. The system architecture recited in claim 1 wherein the spot beams comprise single polarization beams.

9. The system architecture recited in claim 1 wherein the spot beams comprise dual polarization beams.

10. The system architecture recited in claim 1 further comprising:
a scalable ground network comprising L substantially identical gateways and a diversity gateway interconnected by a ground network, each gateway providing 1/M of total forward link and 1/M of total return link transmission capacity of the system architecture, where M is the total number of gateways.

11. The system architecture recited in claim 10 wherein the ground network comprises a fiber network providing gateway interconnections.

12. The system architecture recited in claim 10 wherein the scalable ground network uses Q times the user beam spectrum to reduce the number of gateways in the network by the same factor Q.

13. The system architecture recited in claim 10 wherein the plurality of substantially similar satellites each comprise:
a plurality of multi-beam antennas that produce the required number of user spot beams to cover a desired geographic region and a required number of gateway beams, M.

14. A communication method comprising the steps of:
launching a plurality (N) of active and a number (R) of spare satellites, all of which are substantially similar and substantially collocated at a predetermined orbital location, and wherein the plurality of satellites are configured to provide a plurality of substantially identical spot beams that respectively cover predetermined portions of a desired geographic area, with each respective active satellite providing approximately 1/N of the total transmission capacity;
providing a scalable ground network that is in communication with the plurality of satellites that comprises L substantially identical gateways and a diversity gateway interconnected by a ground network, each gateway providing 1/M of total forward link and 1/M of total return link transmission capacity, where M is the total number of gateways; and
communicating between communication devices located in any of the spot beams via the plurality of satellites and ground network.
